(19) United States
(12) Patent Application Publication
(10) Pub. No.: US 2002/0025061 A1
(43) Pub. Date: Feb. 28, 2002

(54) High speed and reliable determination of lumber quality using grain influenced distortion effects

(76) Inventors: Leonard Metcalfe, Delta (CA); Barry Dashner, Delta (CA)

Correspondence Address: LARSON & TAYLOR, PLC, 1199 NORTH FAIRFAX STREET, SUITE 900, ALEXANDRIA, VA, 22314, US

(21) Appl. No.: 09/931,179

(22) Filed: Aug. 17, 2001

Related U.S. Application Data
(60) Provisional application No. 60/227,015, filed on Aug. 23, 2000.

(51) Int. Cl. G06K 9/00

(52) U.S. Cl. 382/108

(57) ABSTRACT

Disclosed is a high speed electro-optical sensor system to determine quality of objects, such as lumber, having complex structures such as grain, knots and the like. It is particularly concerned with electro-optical sensors useful for this purpose, for example those employing the tracheid or other grain induced distortion effects, or those based on visually discernable defects due to contrast variation. Preferred versions use computer processed data from TV cameras viewing laser spot illumination of boards.

This application claims benefit of U.S. Provisional Applications U.S. Ser. No. 60/227,015 and U.S. Ser. No. 60/227,017.

### CROSS REFERENCES TO RELATED CO-PENDING APPLICATIONS

U.S. Ser. No. 09/______ “Improved Method And Apparatus For Scanning Lumber And Other Objects”, by Metcalfe, Dashner and Porter, filed the same day, the disclosure of which is incorporated herein by reference.

U.S. Ser. No. 09/______ “High Speed Camera Based Sensors”, by Metcalfe and Reuser, filed the same day, the disclosure of which is incorporated herein by reference.

### FIELD OF THE INVENTION

This application is concerned with sensors to determine quality of objects, such as lumber, including more complex structures such as grain. It is particularly concerned with electro-optical sensors and methods useful for this purpose, for example those employing the tracheid effect, or those based on visually discernable defects due to contrast variation.

The invention uses one or more TV cameras whose output is used as input to a computer, such as a PC. This data is analyzed to typically provide information concerning grain direction and/or the presence or characteristics of certain features of objects, such as knots in boards. Knowledge of such information is useful in aiding the classification or grading of board quality.

The invention is particularly useful for grading and other applications relating to wood products, specifically boards moving at high speed on conveyor lines in sawmills, including boards up to 28 feet long moving at 3 boards per second. Reliable operation under these circumstances has not been possible heretofore.

### BACKGROUND OF THE INVENTION

Electro-optical sensing of lumber defects and particularly grain related defects, is exemplified by Soest, U.S. Pat. Nos. 5,703,960, Matthews et al., U.S. Pat. No. 5,252,836; 4,606645; and 3,976,384; and Bouge, U.S. Pat. No. 4,916,629. The disclosures of these patents are incorporated herein fully by reference. Soest gives a useful background to the field, and both Soest and Matthews et al, describe a condition, called the “Tracheid effect” where softwoods are concerned, where reflection of projected light on to a board surface is modified by the grain thereof.

The need for grading aids is well documented and of major importance to the lumber industry. However, despite the work to date in this field, typified by the above patents, the tracheid effect has still not been used successfully in lumber production. The efforts of Soest and coworkers have been substantial, but their approach is limited by a teaching procedure, and a reliance on reflection characteristics of the wood as a whole, and distribution of reflection rather than geometry.

### SUMMARY OF THE INVENTION

This invention describes workable method and apparatus using the tracheid effect, which is simple, fast, and relatively inexpensive. The key is to provide simple apparatus, utilizing direct measurement of the geometric shape of laser beams projected on the wood caused by grain influenced distortion. In addition the inventors have realized that useful results in aiding the grading of wood can be obtained by projecting only a discrete number of points, those points however, having high contrast and detect-ability, and thus providing reliable measures of the wood condition.

### GOALS OF THE INVENTION

It is a goal of the invention to provide simple means by which deviations in grain structure symptomatic of defect conditions in wood can be detected at high speed.

It is a goal of the invention to provide a sensory device, employing at least one photodetector array and projecting on an object multiple projected laser or other light zones, operating at the highest possible operational speed, with acceptable accuracy and at reasonable cost.

It is also a goal of the invention to provide such a device having programmable addressing of pixels of said cameras, and to provide various mechanisms for optimizing the range, speed, resolution, and other attributes of such a device.

It is a further goal of the invention to provide a PSD array camera version of such a device which can operate at ultra high speeds, particularly on longitudinally transported boards.

### BRIEF DESCRIPTION OF THE DRAWINGS

FIG. 1a illustrates a basic arrangement of the device used for aiding the grading of boards, further illustrating the image of a projected round laser beam of Gaussian profile on grain running parallel to the board longitudinal axis.

FIG. 1b is an illustration of the image of a projected round laser beam on grain running at an angle to the board longitudinal axis in the vicinity of a knot, at one instant of time in the movement of the board.

FIG. 2 is a diagram of the grade aiding analysis system of the device.

FIG. 3 is a diagram of a device capable of projecting and analyzing the images of multiple projected beams on a board.

FIG. 4 is a diagram of a PSD Array based embodiment of the invention. This also illustrates the use of a special version of such an array to determine the ellipsoidal vector indicative of the tracheid effect at very high speed.

### EMBODIMENTS OF THE INVENTION

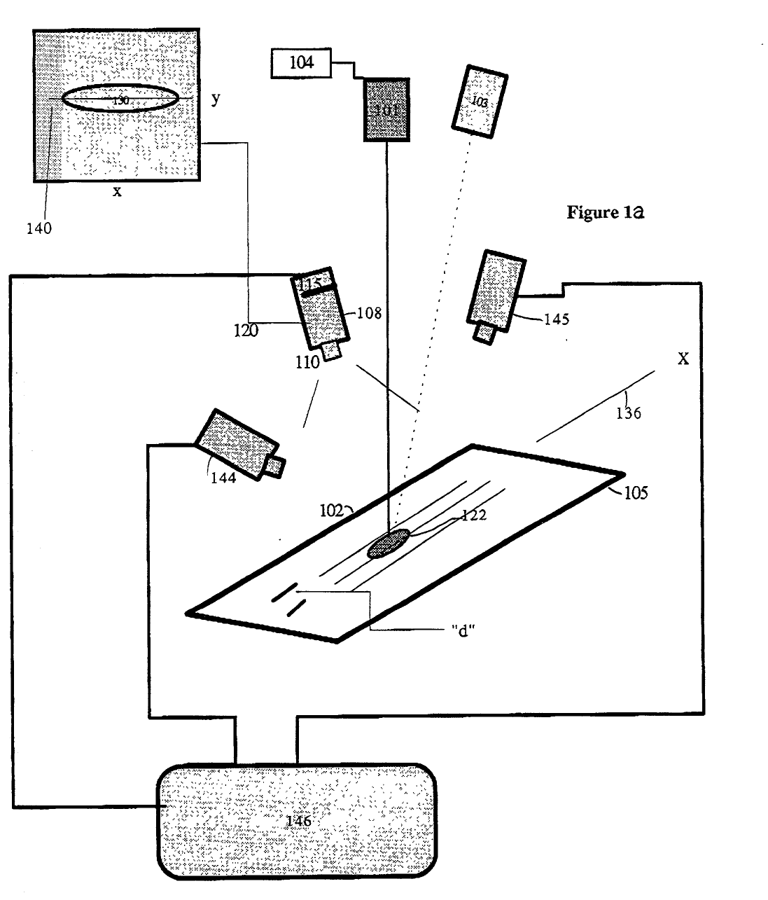

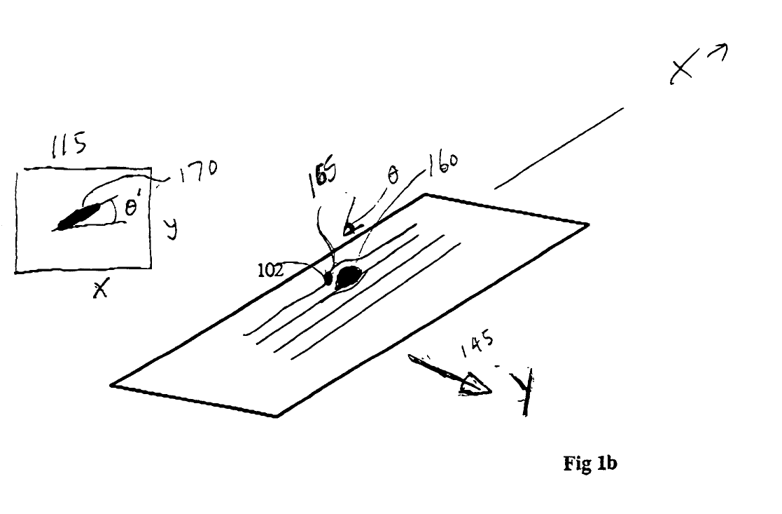

FIG. 1a

FIG. 1a illustrates a basic arrangement of the device usable in the grading of boards. A laser or other suitable light source 101 driven by power module 104 projects a zone of light, in this case a round beam of laser light 102 on the board 105. Typically the size, d, of the zone projected is in the range of one mm. Camera 108, comprising lens 110 and photodetector array 115 images and detects the image of the zone on the board. The photodetector array is preferably a matrix type (also called a solid state TV Camera) for best resolution of axis direction and other zone characteristics (one example, made by Photon Vision is described below, others are available from Fuga, Sony, Photobit and many other sources).

As shown lens 110 images the reflected light from this projection onto a photo-detector array 115 which produces an output 120 indicative of an alteration (often an elongation) of the image 130 of the projected spot by the grain 122 of the board 105. This output corresponds to elongate pattern 130 in the case where the grain represented by lines 122 runs approximately parallel to the board longitudinal axis 136 (a case of a good board). Due to the tracheid or other grain influenced distortion effects, wherein the light tends to “track the grain” so to speak, the image pattern 130 is oval in nature, with the long axis of the image 140 lying in the direction of the grain.

It is noted that it may be desirable to augment the system shown more than one camera to image the zone on the surface of the object. For example, camera 144 and 145 can be used in a manner similar to camera 108 to image the projected zone from different angles such that grain induced effects can be more readily observed. The outputs can then be compared in analysis computer 146.

It should also be noted that the wavelength (i.e. color) of the laser or other light source used can be selected to suit the defect determination requirement. And multiple colors can be used, either simultaneously or in sequence.

For example consider additional laser 103 of color different from that of laser 101, and aligned to illuminate the same zone of the wood (or alternatively a zone nearby). In one example, the camera, if equipped to determine color images can determine grain induced distortion of both zones. In another example, a second camera such as 144 can look only at the color of laser 101, while another camera such as 108 or 145 looks only at 103. Such discrimination is best provided by bandpass filters in the camera optical train using known techniques. It can alternatively be done in the camera itself, using computer discrimination of color (assuming a color responsive TV camera is used).

Blue or green are preferable choices for the colors of light sources 101 or 103, as I have found they provide better contrast enhancement on wood surfaces.

FIG. 1b

Typically, boards are conveyed transversely in sawmills due to their long length (to 28 feet typically) and their high production rate of 2 or more boards per second. Due to board movement 145 in the Y, or transverse direction as shown, a newly presented part of the board in the case illustrated in FIG. 1a, is sequentially presented to the laser spot or other suitable zone 102, and thus imaged by lens 110 onto detector array 115. If the newly examined part of the board 150 is, for example near a knot 160 as shown, the grain 165 deviates from the longitudinal, or X, direction by angle Theta and a resulting image pattern 170 indicative thereof is formed on the detector array 115 as diagrammatically shown.

The long axis 175 of the image formed and its rotation in angle from previous axis 136 is indicative of the direction of the grain, and its deviation from the longitudinal axis (X axis) of the board and thence the presence of a knot or other condition of the wood which it is desired to detect, such conditions typically causing angular deviations of the wood grain around the condition.

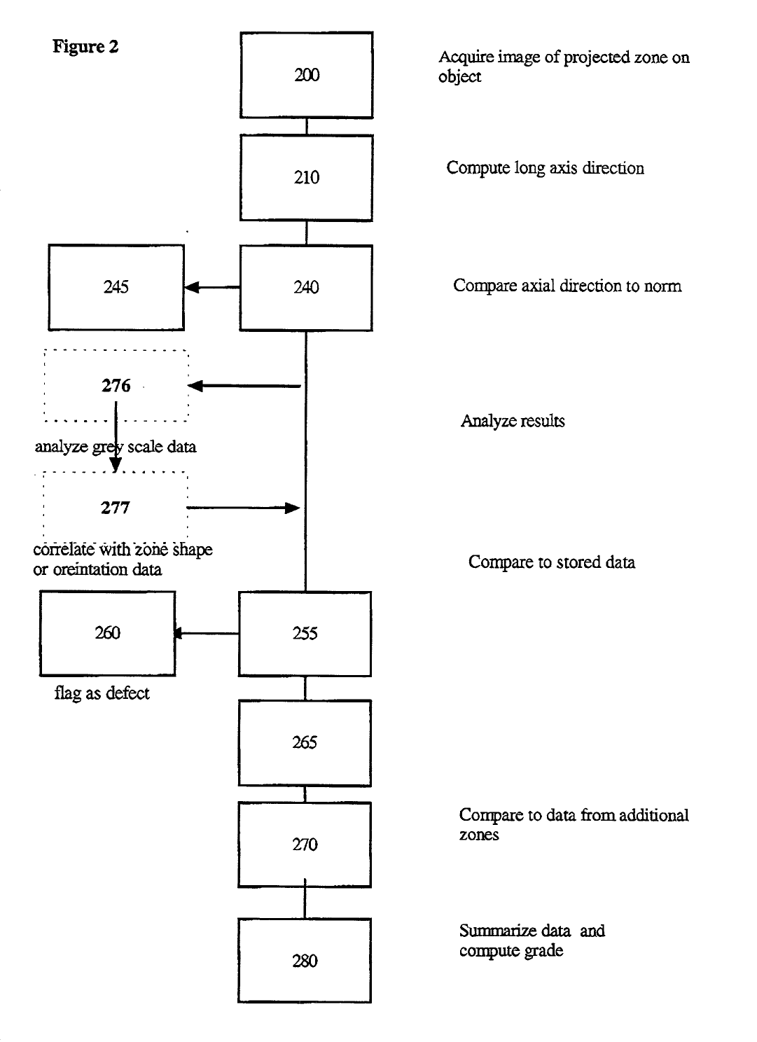

FIG. 2

FIG. 2 is a block diagram of the grade aiding analysis system of the device. The image is acquired 200 of the laser spot on the board. After that, the long axis is computed 210, and compared 220 in angle to a norm for the board (typically longitudinal, plus or minus a tolerance band ). The resultant comparison 240 is then optionally stored in memory 245 together with its location on the board in both X and Y locations, while at the same time, analyzed by analysis computer 255 in order to determine whether such a deviation is acceptable. If not, a decision to flag that zone as a defect is made 260, or alternatively the data can be compared 265 to other stored data before and after the instant data to determine more information concerning the defect in question, such as shape or the like. In addition, data may be compared with that taken from adjacent spots 270, and all data summarized 280 by algorithms determined by the user to determine the grade, or acceptability of the board.

It is noted that the board can be moving transversely (in Y) or longitudinally (in X) and that the detector can look for absolute angle of the spot shape, or changes in angle in order to determine the desired data regarding the board quality and effects therein that relate to board quality or other issues.

To obtain useful information concerning a board, it is necessary to obtain data from a number of points on the board, though not necessarily the total board as one might get if one resorts to point to point scanning using high speed scanners and the like as disclosed by Soest. We have realized in this invention a simplified technique which gets the data required to aid the grading of wood, in a simple manner, typically employing a number of spots projected on a moving board which are all analyzed by the means disclosed above, and the totality of information processed.

It also should be noted that the zone images can be desirably analyzed (using for example analysis computer 146) for their intensity profile (e.g. grayscale), as well as orientation or shape, as illustrated in optional step 276 as shown, which further adds to the knowledge of presence of dark knots and other defects. In addition, such gray scale data can be correlated with spot shape or orientation data in optional step 277 to provide a better understanding of defect location and condition.

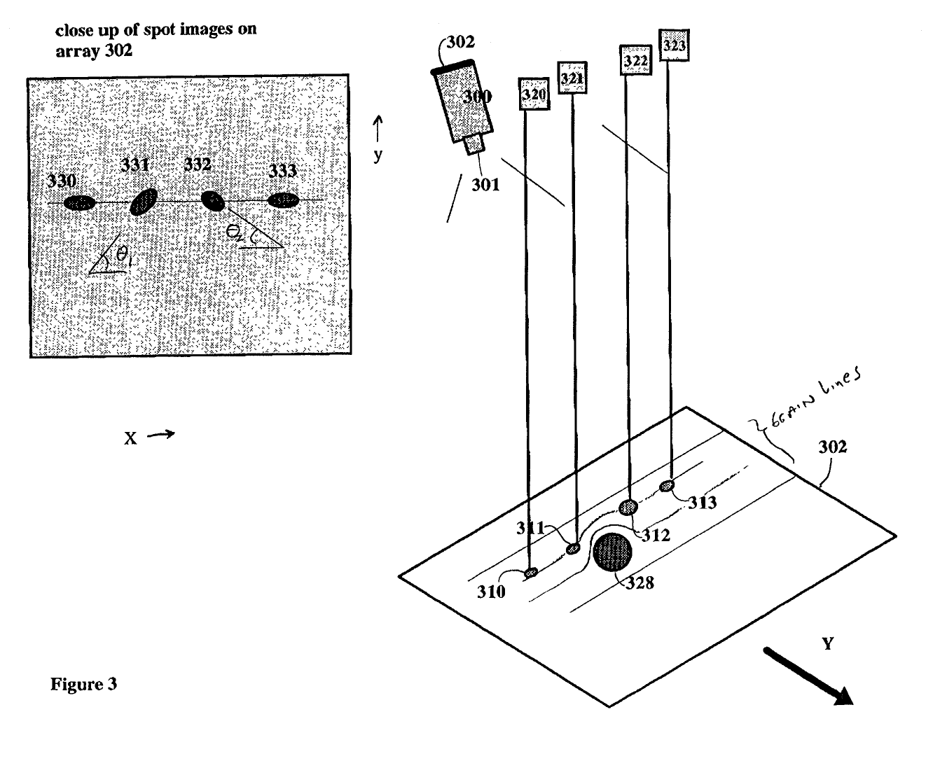

FIG. 3

FIG. 3 is a diagram of a camera device, in this case a pixel addressable camera device of the invention, capable of projecting and analyzing the images of multiple projected beams on a board, to aid the cost-effective and rapid processing of a large number of points needed to characterize defects within a board.

As shown, a camera 300, such as employed in the embodiment of FIG. 1, comprising a lens 301 and a matrix array 302 for example a Photon Vision Systems (Homer, N.Y.) ACS-I active column pixel addressable type, is used to view in this case four projected spots 310-313 from visible semi-conducting diode lasers 320-323 on a board 315, which in turn form spot images 330-333 on detector array 302 as shown. Alternatively, suitable light sources other than such laser sources may also be used.

As can be seen images 320 and 323 are un-deviated by knot 328, while 321 and 322 are deviated, in this case in opposite angular directions theta 1 and theta 2. The raw angles, theta, changes in theta, and/or the variation in direction of theta between different projected spot images in either space or time, can all be used as indicator of knot (or other defect) presence, size and severity. The time duration of such effects in the direction of motion, Y, also is indicative as can be appreciated, of knot extent and other abnormalities of the surface. For example, for boards moving the same velocity, a rapid “blip” of slope change indicates a smaller defect than the same slope variation from the desired longitudinal grain case enduring over a longer time period.

The pixel addressable array is unique compared to normal raster scanned arrays, in that one can scan just pixels, or pixel regions of interest. In this case once an initial value of pixel location y1 is determined in the y direction of the array the pixels to be scanned can all be in a general band y1+/− a where “a” is a tolerance band indicative of board height caused variations, and spot image size variation.

Only pixels in this band need to be scanned out to determine the answers needed for the invention. Indeed, one can actually scan only pixels in the windows around the images, such as a band =/−b around each image centroid. This could be only 3 pixels wide and still find the angle theta related information for each zone image.

Such as system can be extremely fast, a desired characteristic. For example, if one scans 5 pixels×5 pixels in x and y for each spot image, and there are 4 spots, this means only 100 pixels need be scanned per image, as shown in diagram 350. At a 10 mhz camera scan rate, this is 100,000 scans per second. More spots than four, also arrayed in both x and y directions of the array can be used, though as the number of spots to be detected goes up, so does the number of pixels by the same amount.

A preferred arrangement for transverse moving boards, is where 20 spots are projected on to the board in an axial row at 1 inch intervals (i.e. a 20 inch swath, per sensor).

Windows of 10×10 pixels are scanned, and with 20 spots this is 2000 pixels per array scan, or 5,000 scans per second at a 10 mhz pixel scan rate.

As the board moves past the row of spots through at 50 inches per second, this means that data for a new spot ellipse determination is scanned every 0.01 inch of board travel.

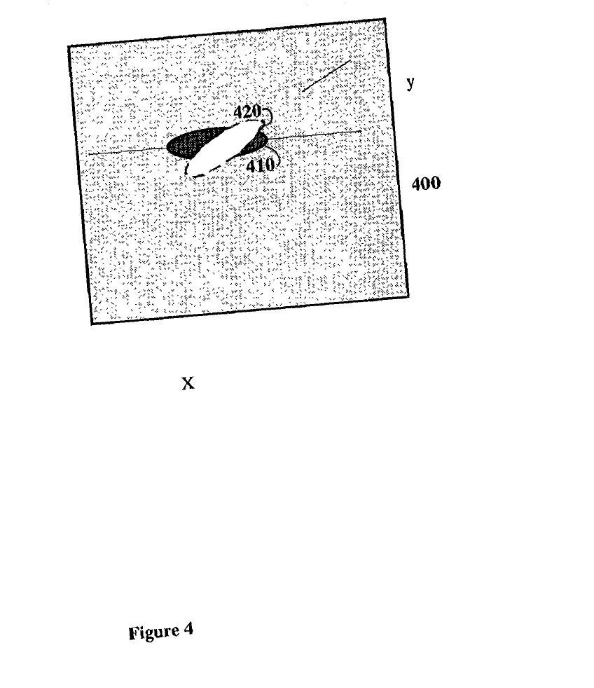

FIG. 4

FIG. 4 illustrates an embodiment of the invention using an array of PSD (position sensitive photodiode) detectors such as shown in our co-pending application referenced above, “Improved method and apparatus for scanning lumber and other objects”, FIG. 8, to determine the ellipsoidal vector indicative of the tracheid effect at very high speed. Unlike FIG. 3 above, each of the spot images 330-333 would fall on a separate photodetector which is a biaxial PSD type capable of determining a centroid of photon energy in both X and Y locations on surface.

Consider biaxial PSD detector 400, when the image pattern is oblong and in the general grain direction like that of 130 above. In this case the image 410 is elliptical with the long axis aligned with the x axis of the PSD Chip. If however the image pattern 420 is like that of 170 above, corresponding to grain deviation theta in the presence of a knot, then PSD output is modified due to distortion of the spot from its previous condition. By monitoring PSD output voltages, one can determine such deviations—often at speeds of over 100 kHz. Such speeds are desirable particularly when boards are moving longitudinally through a row of projected spots, often at 100s of inches/sec.

The above can also be done advantageously using a special biaxial version of a smart PSD array such as that developed by In3D corporation (www.in3d.nl) to provide vectors directly.

It should be noted that the variation of reflectance of light from the object at different parts of the object is often substantial, and in this case the dynamic range of the photo-detector array or PSD is often insufficient to account for variations in light gathered from the object unless some type of closed loop laser control is performed so as to keep the light gathered by the sensor with in the dynamic range of the array or PSD device.

For example, in a preferred embodiment, laser power or on-time duration is adjusted, for example with power adjusting modules, such as 104 for each of what can be multiple laser projectors based on the light detected from the object at each zone by the photodetector array of the camera.

Typical lasers used with the above invention are semi conducting diode lasers of visible (e.g. red) or near IR wavelengths having output powers on the order of 10-30 mw if used on high speed board measurement.

It is understood that the invention comprehends projection of different shaped zones, not just spots, whose alteration in reflected image shape and/or axial orientation may be used to give as desired answer with respect to the presence of object defects or other conditions. For example, a line in the direction of desired grain (e.g. longitudinal to the board axis) can be projected, a line whose image is linear for good wood, and highly modified by knots.

Another example includes the projection of an arbitrary zone, whose shape or orientation on viewing can be taught to the system using known objects and used to compare subsequent test objects.

While described mainly for use on boards and logs moving high speed, the invention herein may be used on any object for which multiple object point locations, thickness', or other dimensions are desired.

What is claimed is

1. A method for determining characteristics of an object having a grained surface, comprising the steps of:
providing a light source;
providing a TV camera;
with said light source, projecting a zone of light on said object;
imaging said zone of light on said object with said TV camera to provide zone image data which is dependent on the grain of said object, and
analyzing said zone image data to determine at least one characteristic of said object.

2. A method according to claim 1 wherein said object is lumber.

3. A method according to claim 1 including the further step of determining the quality of said object using said axis data.

4. A method according to claim 3 wherein said quality is related to the grade of said lumber.

5. A method according to claim 1 wherein a plurality of zones are projected at a plurality of spaced positions on said object.

6. A method according to claim 1 wherein said projected zone is a spot.

7. A method according to claim 1 wherein said TV camera employs a photo-detector array.

8. A method according to claim 7 wherein said array is pixel addressable.

9. A method according to claim 1 wherein said analysis step includes determining from said zone image data, at least one axis of said zone image indicative of said grain.

10. A method according to claim 9 including the further step of determining the angle of said zone image axis.

11. A method according to claim 9 including the further step of determining a change in angle of said zone image axis.

12. A method according to claim 9 including the further step of determining the angle of said zone image axis from a norm.

13. A method according to claim 12 wherein said norm is represented by an axis substantially parallel to the axis of said object.

14. A method according to claim 1 wherein said light source is a laser.

15. A method according to claim 1 wherein said light source is controlled to allow operation over a wide range of object reflectivity conditions.

16. A method according to claim 1 wherein a parameter of said TV camera is controlled to allow operation over a wide range of object reflectivity conditions.

17. A method according to claim 1 wherein said light source and said TV camera are controlled to allow operation over a wide range of object reflectivity conditions.

18. A method according to claim 1 wherein said TV camera employs at least one PSD detector.

19. A method according to claim 5 wherein only a fraction of the object is illuminated.

20. A method according to claim 1 wherein more than one TV camera is employed to image said zone.

21. A method according to claim 1 wherein more than light source is employed project a zone on said object.

22. A method according to claim 1 wherein said projected zone is of arbitrary shape.

23. A method according to claim 1 including the further step of determining the grayscale intensity value of points within said zone image.
